(19) United States
(12) Patent Application Publication
(10) Pub. No.: US 2018/0057416 A1
(43) Pub. Date: Mar. 1, 2018

(54) Solvent Release Layer Methods of Making Polymer Derived Ceramic Flakes

(71) Applicants: Melior Innovations Inc., Houston, TX (US); Sun Chemical Corporation, Parsippany, NJ (US)

(72) Inventors: Lisa Clapp, Cincinnati, OH (US); Michael Mueller, Katy, TX (US); Jonnath Doll, Cincinnati, OH (US)

(73) Assignees: Melior Innovations Inc., Houston, TX (US); Sun Chemical Corporation, Parsippany, NJ (US)

(21) Appl. No.: 15/716,266

(22) Filed: Sep. 26, 2017

(51) Int. Cl. C04B 41/91; B01J 2/26; C04B 41/00; C04B 41/53

(52) U.S. Cl. CPC C04B 41/91; B01J 2/26; C04B 2235/483; C04B 41/53; C04B 41/009

(57) ABSTRACT

A soluble release layer method for making cured polymer derived ceramic flakes. Adding a release layer onto a substrate, curing the release layer and then adding a liquid polymer derived ceramic (PDC) to the release layer and then curing the PDC layer on the release layer. Using a solvent jet to simultaneously cut and release the PDC layer into isolated flakes.

### BACKGROUND OF THE INVENTION

### Field of the Invention

The present inventions relate to apparatus and methods to make thin volumetric shapes of polymer derived ceramic materials. In particular, embodiments of the present inventions include methods and apparatus for making cured, e.g., plastic, and ceramic thin volumetric shapes using silicon, oxygen and carbon containing polymer derived ceramics.

As used herein, unless stated otherwise, room temperature is 25° C. And, standard temperature and pressure is 25° C. and 1 atmosphere.

Generally, the term “about” as used herein unless specified otherwise is meant to encompass a variance or range of ±10%, the experimental or instrument error associated with obtaining the stated value, and preferably the larger of these.

### SUMMARY

There has been a long standing and developing need for methods and apparatus to make polymer derived ceramic thin volumetric shapes, such as platelets, flakes, chips, discs, shavings, and slivers. The present inventions, among other things, solve these needs by providing the compositions of matter, materials, articles of manufacture, devices and processes taught, disclosed and claimed herein.

There is provided a release layer embodiment of adding a release layer onto a substrate, curing the release layer and then adding a liquid polymer derived ceramic (PDC) to the release layer and then curing the PDC layer on the release layer. The “adding” is broadly defined to include any manner in which either the release material is placed on the substrate, or the PDC material is placed on the release layer. There is provided an embodiment of this PDC layer, release layer, substrate embodiment wherein, multiple layers of material are placed on a single substrate, e.g., PDC/release/PDC/release PDC/release/substrate.

There is provided an embodiment of using solvents to remove the release layer; wherein the solvents may also be used as a cutting jet to cut the PDC/release/substrate multilayer structures into flakes, platelets, discs, while also dissolving the release layer.

There is provided a system for and a method of, making thin volumetric shapes of polymer derived ceramic materials, the method having the steps of: delivering a liquid release material on a surface of a substrate layer, whereby a liquid release layer is formed on the surface of the substrate; converting the liquid release layer to a solid release layer; delivering a liquid polymer derived ceramic material to a surface of the solid release layer, whereby a liquid polymer derived ceramic layer is formed on the surface of the solid release layer; curing the liquid polymer derived ceramic layer; thereby forming a cured polymer derived ceramic layer; and thereby forming a multilayer structure having a substrate layer, release layer and polymer derived ceramic layer; and, subjecting the multilayer structure to a solvent cutting jet; wherein the solvent cutting jet comprises a solvent for the release layer, and has sufficient pressure to cut the multilayer structure; wherein thin volumetric shapes of cured polymer derived ceramic materials are formed, free from the solid release layer and the substrate.

Yet further there is provided these methods and systems having one or more of the following features: wherein the substrate is moving; wherein the solvent is water; wherein the release layer material is selected from the group of materials consisting of polyvinylpyrrolidone, polyvinylacetate, polyviinylalcohol, crosslinked polyethylene oxide, carboxy methyl cellulose, and hydroxy ethyl cellulose; and wherein the polymer derived ceramic material is a polysilocarb.

Moreover, there is provided a system and method of making thin volumetric shapes of polymer derived ceramic materials, the method having the steps of: delivering a liquid release material on a surface of a substrate layer, whereby a liquid release layer is formed on the surface of the substrate; converting the liquid release layer to a solid release layer; delivering a liquid polymer derived ceramic material to a surface of the solid release layer, whereby a liquid polymer derived ceramic layer is formed on a surface of the solid release layer; curing the liquid polymer derived ceramic layer; thereby forming a cured polymer derived ceramic layer; and thereby forming a first multilayer structure having a substrate layer, release layer and polymer derived ceramic layer; delivering a liquid release material on a surface of the first multilayer structure, whereby a liquid release layer is formed on a surface of the polymer derived ceramic layer of the first multilayer structure; converting the liquid release layer to a solid release layer; delivering a liquid polymer derived ceramic material to a surface of the solid release layer, whereby a liquid polymer derived ceramic layer is formed on a surface of the solid release layer; curing the liquid polymer derived ceramic layer; thereby forming a cured polymer derived ceramic layer; and thereby forming a second multilayer structure having a substrate layer, release layer, polymer derived ceramic layer, release layer, and polymer derived ceramic layer; and subjecting the second multilayer structure to a solvent cutting jet; wherein the solvent cutting jet comprises a solvent for the release layer, and has sufficient pressure to cut the second multilayer structure; wherein thin volumetric shapes of cured polymer derived ceramic materials are formed, free from the solid release layer, each other, and the substrate.

Still further there is provided these systems and methods having one or more of the following features: wherein the shapes are flakes; wherein the flakes are substantially planar; and wherein the flakes are planar.

### BRIEF DESCRIPTION OF THE DRAWINGS

FIG. 1 is a schematic diagram of an embodiment of a system and process in accordance with the present inventions.

FIG. 2 is a schematic cross section of an embodiment of a multilayer structure in accordance with the present inventions.

### DESCRIPTION OF THE PREFERRED EMBODIMENTS

In general, the present inventions relate to systems, apparatus and processes for making polymer derived ceramic planar volumetric shapes for use as, or in, colorants, inks, pigments, dyes, and additives.

Polymer derived ceramics (PDC) are ceramic materials that are derived from, e.g., obtained by, the pyrolysis of polymeric materials. These materials are typically in a solid or semi-solid state that is obtained by curing an initial liquid polymeric precursor, e.g., PDC precursor, PDC precursor formulation, precursor batch, and precursor. The cured, but unpyrolized, polymer derived material can be referred to as a preform, a PDC preform, the cured material, and similar such terms. Polymer derived ceramics may be derived from many different kinds of precursor formulations, e.g., starting materials, starting formulations. PDCs may be made of, or derived from, carbosilane or polycarbosilane (Si—C), silane or polysilane (Si—Si), silazane or polysilazane (Si—N—Si), silicon carbide (SiC), carbosilazane or polycarbosilazane (Si—N—Si—C—Si), siloxane or polysiloxanes (Si—O), to name a few.

A preferred PDC is “polysilocarb”, e.g., material containing silicon (Si), oxygen (O) and carbon (C). Polysilocarb materials may also contain other elements. Polysilocarb materials can be made from one or more polysilocarb precursor formulation or precursor formulation. The polysilocarb precursor formulations can contain, for example, one or more functionalized silicon polymers, other polymers, non-silicon based cross linking agents, monomers, as well as, potentially other ingredients, such as for example, inhibitors, catalysts, initiators, modifiers, dopants, fillers, reinforcers and combinations and variations of these and other materials and additives. Silicon oxycarbide materials, SiOC compositions, and similar such terms, unless specifically stated otherwise, refer to polysilocarb materials, and would include liquid materials, solid uncured materials, cured materials, and ceramic materials.

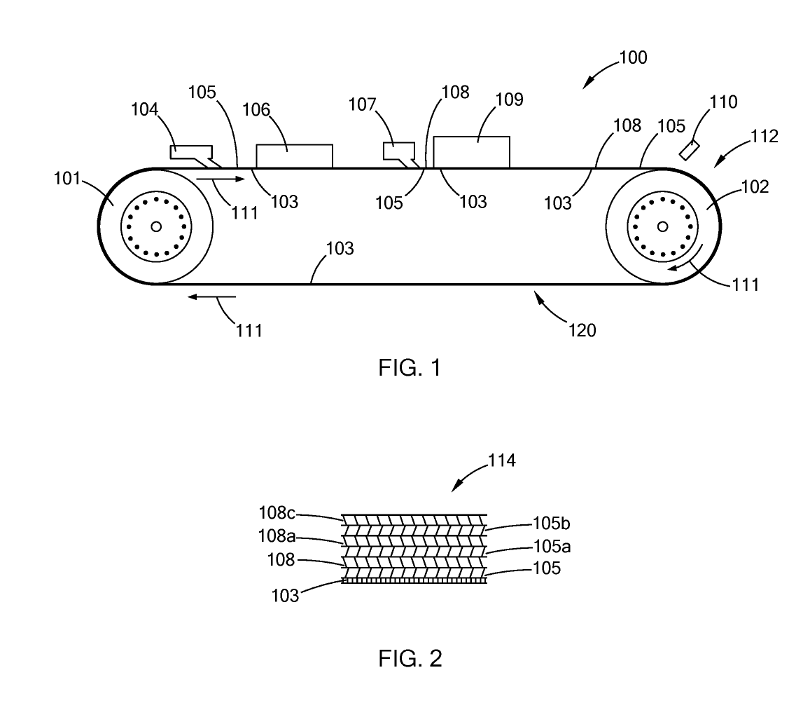

Turning to FIG. 1 there is provided a schematic of a system 100 for making thin volumetric shaped cured PDC structures.

These thin volumetric shaped structures would include, for example, any structures where the surface area, or the longest width or length dimension, is significantly larger than its thickness, e.g., 3:1, 5:1, 10:1, 15:1, etc. Examples of such thin volumetric shapes would be flakes, disks, lenses, panels, platelets, slivers, chips and shavings. Preferably, the thin volumetric shapes are substantially planar (i.e., about 90% of their surface falls within a single plane) and planar (i.e., at least about 99.9% of their surface falls within a single plane). Although other non-planar shapes are contemplated, such as for example, potato chip shape, cornflake shape, a shape having ruffles or ridges, and combinations of these and other shapes.

In the embodiment of the system of FIG. 1 the system 100 has a continuous substrate 103 that is driven by rollers 101, 102 in the direction of arrows 111. It being understood that the substrate could be non-continuous, e.g., a flat plate, a sheet that is moved in a single pass, or other types of batch, continuous, and semi-continuous configurations.

In operation, the substrate 103 is moved under the release layer applicator device 104. Applicator device 104, applies the release layer 105 to the substrate 103. Applicator device 104 can be, for example, a spray arm, a roller, a slice, or other device or apparatus for placing a thin layer of liquid material on the moving substrate 103 to form the release layer 105. The release layer 105 is then carried by the substrate 103 to a curing, or drying, apparatus 106, where the release layer 105 is solidified.

The solidified release layer 105 is then carried by substrate 103 to a second applicator device, a PDC applicator device 107, which forms a layer of liquid PDC material on the surface of the solid release layer 105, thus forming PDC layer 108. The substrate 103 then carries the liquid PDC layer (having the solid release layer 105 located between the liquid PDC layer 108 and the substrate 103) to the PDC layer curing apparatus 109, where the liquid PDC layer 108 is cured into a solid PDC layer 108.

The cured PDC layer 108 (which is on top of the solid release layer 105, which is on top of the substrate 103) is then carried to a cutting jet 110. The cutting jet 110 uses a pressurized stream, or jet, of a fluid that is a solvent for the release layer. In this manner, the cutting jet can cut the PDC layer 108 into smaller flat thin shapes and dissolve the release layer 105, thus freeing the PDC shapes from the substrate, each other, and from the release layer. It being understood that solvent baths can be used, solvent washes, mechanical, fluid, laser and other types of cutters can be used, and combinations and variations of these can be used.

In an embodiment of the process, the PDC layer/release layer/substrate combination 112 is not cut, or otherwise subjected to a solvent for the release layer 105. Instead the PDC layer/release layer/substrate combination 112 travels around (in the direction of arrows 111) and returns under the release layer applicator 104 where a second release layer 105a, is applied to PDC layer 108. Release layer 105a is then cured or dried by apparatus 106 and a second PDC layer 108a is applied on top of release layer 105a. The second PDC layer 108a is then cured to from a cured, e.g., solid PDC layer 108a. This process can be repeated, adding additional release layer 105b and PDC layer 108b, until a multi-layer structure 114, as shown for example in FIG. 2 is formed. Additional layers are also contemplated.

This multilayer structure 114 is then cut by jet 110, or otherwise subjected to a solvent-cutting process to form flakes, platelets or other thin volumetric structures, and in an embodiment structures that are substantially planar and in an embodiment structures that are planar.

It being understood that the spacing and configuration of the system of FIG. 1 can be modified and changed, such as for example, by adding additional drying or curing apparatus, adding additional applicators, and lengthen or changing the spacing of the system. Additionally, processes such as the solvent-cutting process can be performed on the return portion 120 of the system.

The cured thin shaped PDC material can then be collected and pyrolized to convert the cured PDC material into a ceramic PDC material, in the shape of a flake, platelet, disk, or other thin volumetric shape, which in embodiments can be substantially planar, and in embodiments planar.

Precursor formulations, including the polysilocarb precursor formulations, as well as others, are cured to form a solid, semi-sold, or plastic like material by the curing device(s) in the system. In curing, the polysilocarb precursor formulation may be processed through an initial cure, to provide a partially cured material, which may also be referred to, for example, as a preform, green material, or green cure (not implying anything about the material's color). The green material may then be further cured. Thus, one or more curing steps may be used. The material may be “end cured,” i.e., being cured to that point at which the material has the necessary physical strength and other properties for its intended purpose. The amount of curing may be to a final cure (or “hard cure”), i.e., that point at which all, or essentially all, of the chemical reaction has stopped (as measured, for example, by the absence of reactive groups in the material, or the leveling off of the decrease in reactive groups over time). Thus, the material may be cured to varying degrees, depending upon its intended use and purpose, as well as, any subsequent processing requirements. Thus, for example, the material should be cured sufficiently to permit the layering and solidification of a second release layer for the multi-layered embodiment of FIG. 2.

The release layer material may be any material that is soluble in a solvent that does not dissolve the PDC layer. Preferably the solvent is water and the release layer is a water soluble material, such as Polyvinylpyrrolidone—PVP; Polyvinylacetate—PVAc; Polyviinylalcohol—PVOH; Crosslinked polyethylene oxide—POLYOX (Dow); Carboxy methyl cellulose—CMC; and Hydroxy ethyl cellulose.

The curing may be done at standard ambient temperature and pressure (“SATP”, 1 atmosphere, 25° C.), at temperatures above or below that temperature, at pressures above or below that pressure, and over varying time periods. The time for the curing can be from a few seconds (e.g., less than about 1 second, less than 5 seconds), to less than a minute, to minutes. The curing may also be conducted in any type of surrounding environment, including for example, gas, liquid, air, water, inert atmospheres, N₂, Argon, flowing gas (e.g., sweep gas), static gas, reduced O₂, reduced pressure, elevated pressure, ambient pressure, controlled partial pressure and combinations and variations of these and other processing conditions.

Preferably, in embodiments where the PDC material is a polysilocarb PDC material, the curing takes place at temperatures in the range of from about 5° C. or more, from about 20° C. to about 250° C., from about 20° C. to about 150° C., from about 75° C. to about 125° C., and from about 80° C. to 90° C. Although higher and lower temperatures and various heating profiles, (e.g., rate of temperature change over time (“ramp rate”, e.g., Δ degrees/time), hold times, and temperatures) can be utilized.

Curing, drying or both, of the release layer or the PDC layer may be accomplished by any type of heating apparatus, or mechanisms, techniques, or morphologies that has the requisite level of temperature and environmental control, for example, heated water baths, electric furnaces, microwaves, gas furnaces, furnaces, forced heated air, towers, spray drying, falling film reactors, fluidized bed reactors, lasers, indirect heating elements, direct heating, infrared heating, UV irradiation, and an RF furnace.

The invention may be embodied in other forms than those specifically disclosed herein without departing from its spirit or essential characteristics. The described embodiments are to be considered in all respects only as illustrative and not restrictive.

1. A method of making thin volumetric shapes of polymer derived ceramic materials, the method comprising:
a. delivering a liquid release material on a surface of a substrate layer, whereby a liquid release layer is formed on the surface of the substrate;
b. converting the liquid release layer to a solid release layer;
c. delivering a liquid polymer derived ceramic material to a surface of the solid release layer, whereby a liquid polymer derived ceramic layer is formed on the surface of the solid release layer;
d. curing the liquid polymer derived ceramic layer; thereby forming a cured polymer derived ceramic layer; and thereby forming a multilayer structure comprising a substrate layer, release layer and cured polymer derived ceramic layer; and,
e. subjecting the multilayer structure to a solvent cutting jet; wherein the solvent cutting jet comprises a solvent for the release layer, and has sufficient pressure to cut the multilayer structure;
f. wherein thin volumetric shapes of cured polymer derived ceramic materials are formed, free from the solid release layer and the substrate.

2. The method of claim 1, wherein the substrate is moving.

3. The method of claim 1, wherein the solvent is water.

4. The method of claim 1, wherein the release layer material is selected from the group of materials consisting of polyvinylpyrrolidone, polyvinylacetate, polyviinylalcohol, crosslinked polyethylene oxide, carboxy methyl cellulose, and hydroxy ethyl cellulose.

5. The methods of claim 1, 2, 3 or 4, wherein the polymer derived ceramic material is a polysilocarb.

6. A method of making thin volumetric shapes of polymer derived ceramic materials, the method comprising:
a. delivering a liquid release material on a surface of a substrate layer, whereby a liquid release layer is formed on the surface of the substrate;
b. converting the liquid release layer to a solid release layer;
c. delivering a liquid polymer derived ceramic material to a surface of the solid release layer, whereby a liquid polymer derived ceramic layer is formed on a surface of the solid release layer;
d. curing the liquid polymer derived ceramic layer; thereby forming a cured polymer derived ceramic layer; and thereby forming a first multilayer structure comprising a substrate layer, release layer and polymer derived ceramic layer;
e. delivering a liquid release material on a surface of the first multilayer structure, whereby a liquid release layer is formed on a surface of the polymer derived ceramic layer of the first multilayer structure;
f. converting the liquid release layer of step e to a solid release layer;
g. delivering a liquid polymer derived ceramic material to a surface of the solid release layer of step f, whereby a liquid polymer derived ceramic layer is formed on a surface of the solid release layer of step f;
h. curing the liquid polymer derived ceramic layer of step g; thereby forming a cured polymer derived ceramic layer; and thereby forming a second multilayer structure comprising a substrate layer, release layer, polymer derived ceramic layer, release layer, and polymer derived ceramic layer; and.
i. subjecting the second multilayer structure to a solvent cutting jet; wherein the solvent cutting jet comprises a solvent for the release layer, and has sufficient pressure to cut the second multilayer structure;
j. wherein thin volumetric shapes of cured polymer derived ceramic materials are formed, free from the solid release layer, each other, and the substrate.

7. The method of claim 6, wherein the substrate is moving.

8. The method of claim 6, wherein the solvent is water.

9. The method of claim 6, wherein the release layer material is selected from the group of materials consisting of polyvinylpyrrolidone, polyvinylacetate, polyviinylalcohol, crosslinked polyethylene oxide, carboxy methyl cellulose, and hydroxy ethyl cellulose.

10. The methods of claim 6, 7, 8 or 9, wherein the polymer derived ceramic material is a polysilocarb.

11. The method of claim 1, wherein the shapes are flakes.

12. The method of claim 11, wherein the flakes are substantially planar.

13. The method of claim 12, wherein the flakes are planar.

14. The method of claim 6, wherein the shapes are flakes.

15. The method of claim 14, wherein the flakes are substantially planar.

16. The method of claim 15, wherein the flakes are planar.

17. A method of making thin volumetric shapes of polymer derived ceramic materials, the method comprising:
a. delivering a liquid release material on a surface of a substrate layer, whereby a liquid release layer is formed on the surface of the substrate;
b. converting the liquid release layer to a solid release layer;
c. delivering a liquid polymer derived ceramic material to a surface of the solid release layer, whereby a liquid polymer derived ceramic layer is formed on the surface of the solid release layer;
d. curing the liquid polymer derived ceramic layer; thereby forming a cured polymer derived ceramic layer; and thereby forming a multilayer structure comprising a substrate layer, release layer and a cured polymer derived ceramic layer;
e. delivering the liquid release material on a surface of the cured polymer derived ceramic layer, whereby a second liquid release layer is formed on the surface of the cured polymer derived ceramic layer;
f. converting the second liquid release layer to a second solid release layer;
g. delivering the liquid polymer derived ceramic material to a surface of the second solid release layer, whereby a second liquid polymer derived ceramic layer is formed on the surface of the second solid release layer;
h. curing the second liquid polymer derived ceramic layer; thereby forming a second cured polymer derived ceramic layer; and thereby forming a multilayer structure comprising a substrate layer, release layer, polymer derived ceramic layer, a second release layer and a second cured polymer derived ceramic layer; and,
i. subjecting the multilayer structure to a solvent cutting jet; wherein the solvent cutting jet comprises a solvent for the release layer, and has sufficient pressure to cut the multilayer structure;
j. wherein thin volumetric shapes of cured polymer derived ceramic materials are formed, free from the solid release layers and the substrate.

18. The method of claim 17, comprising the further steps of:
(i) delivering the liquid release material on a surface of the second cured polymer derived ceramic layer, whereby a third liquid release layer is formed on the surface of the second cured polymer derived ceramic layer;
(ii) converting the third liquid release layer to a third solid release layer;
(iii) delivering the liquid polymer derived ceramic material to a surface of the third solid release layer, whereby a third liquid polymer derived ceramic layer is formed on the surface of the third solid release layer;
(iv) curing the third liquid polymer derived ceramic layer; thereby forming a third cured polymer derived ceramic layer; and thereby forming the multilayer structure, wherein the multilayer structure comprises a substrate layer, release layer, cured polymer derived ceramic layer, a second release layer, a second cured polymer derived ceramic layer, a third release layer and a third cured polymer derived ceramic layer;
wherein steps (i)-(iv) are performed after step (h) and before step (i).
